(19) United States
(12) Patent Application Publication
(10) Pub. No.: US 2026/0368771 A1
(43) Pub. Date: Nov. 19, 2026

(54) MANAGING CARBON EMISSIONS IN CLOUD COMPUTING ENVIRONMENTS

(71) Applicant: International Business Machines Corporation, Armonk, NY (US)

(72) Inventors: Charan ACHARYA CHANDRASHEKAR, Bangalore (IN); Rachana VISHWANATHULA, Hyderabad (IN); Raja RAHUL, Visakhapatnam (IN); Srikkanth KULKARNI, Bangalore (IN)

(21) Appl. No.: 19/211,764

(22) Filed: May 19, 2025

(51) Int. Cl. G06Q 30/0207; G06F 16/22

(52) U.S. Cl. CPC G06Q 30/0207; G06F 16/2246

(57) ABSTRACT

In some implementations, a computer system may receive server data identifying a plurality of server devices and factors that influence carbon emissions of the plurality of server devices, and may calculate, for each of the plurality of server devices, carbon credits to execute a unit of work at different time periods, where the carbon credits to execute the unit of work at different time periods form a plurality of carbon credits associated with the plurality of server devices. The computer system may generate an ordered data structure that arranges identifiers of the plurality of server devices based on the plurality of carbon credits, and may utilize the ordered data structure to select one of the plurality of server devices with a quantity of carbon credits to process requests generated by an application for a time period.

### BACKGROUND

Cloud computing generally involves remote delivery of computing resources and services over the Internet. The computing resources and services may be provided by various providers and may be utilized by various customers.

### SUMMARY

Some implementations described herein relate to a method. The method may include receiving server data identifying a plurality of server devices and factors that influence carbon emissions of the plurality of server devices. The method may include calculating, for each of the plurality of server devices, carbon credits to execute a unit of work at different time periods, where the carbon credits to execute the unit of work at different time periods form a plurality of carbon credits associated with the plurality of server devices. The method may include generating an ordered data structure that arranges identifiers of the plurality of server devices based on the plurality of carbon credits.

Some implementations described herein relate to a computer system. The computer system may include a processor set, one or more computer-readable storage media, and program instructions stored on the one or more computer-readable storage media to cause the processor set to perform operations. The operations may include receiving server data identifying a plurality of server devices and factors that influence carbon emissions of the plurality of server devices, and calculating, for each of the plurality of server devices, carbon credits to execute a unit of work at different time periods, where the carbon credits to execute the unit of work at different time periods form a plurality of carbon credits associated with the plurality of server devices. The operations may include generating an ordered data structure that arranges identifiers of the plurality of server devices based on the plurality of carbon credits, and monitoring the plurality of server devices. The operations may include updating the ordered data structure based on monitoring the plurality of server devices.

Some implementations described herein relate to a computer program product. The computer program product may include one or more computer-readable storage media and program instructions stored on the one or more computer-readable storage media to perform operations. The operations may include receiving server data identifying a plurality of server devices and factors that influence carbon emissions of the plurality of server devices. The operations may include calculating, for each of the plurality of server devices, carbon credits to execute a unit of work at different time periods, where the carbon credits to execute the unit of work at different time periods form a plurality of carbon credits associated with the plurality of server devices. The operations may include generating an ordered data structure that arranges identifiers of the plurality of server devices based on the plurality of carbon credits, and receiving application data identifying an application provided by the plurality of server devices and historical requests associated with the application. The operations may include calculating an average carbon credit required by the application based on the application data.

### BRIEF DESCRIPTION OF THE DRAWINGS

FIG. 1 is a diagram of an example computing environment for managing carbon emissions in cloud computing environments, as described herein.

FIGS. 2A-2H are diagrams of an example associated with managing carbon emissions in cloud computing environments.

FIG. 3 is a flowchart of an example process associated with managing carbon emissions in cloud computing environments.

### DETAILED DESCRIPTION

The following detailed description of example implementations refers to the accompanying drawings. The same reference numbers in different drawings may identify the same or similar elements.

Cloud computing has become an essential aspect of modern enterprise operations, with many companies choosing cloud vendors based on their sustainability requirements. Sustainability in cloud computing depends on various factors, including an energy mix of grids for data centers, information technology (IT) workload optimization, and non-IT power usage. An important metric for sustainability is carbon emissions, which are calculated as a product of power consumed and carbon intensity. To minimize energy consumption and environmental impact, cloud service providers employ sustainable scheduler techniques to allocate computing resources efficiently. However, existing sustainable scheduler techniques often focus solely on reducing energy consumption without considering carbon credit limits of individual applications. As a result, applications may exhaust allocated carbon credits prematurely, rendering the applications unable to process future requests. This may lead to inefficient resource utilization, increased costs, and compromised sustainability goals. Thus, current methods for managing cloud computing environments consume computing resources (e.g., processing resources, memory resources, communication resources, and/or the like), networking resources, and/or the like associated with failing to process future requests of an application, handling customer complaints associated with handling future requests of an application, utilizing server devices incapable of processing request of an application while satisfying sustainability goals, and/or the like.

Some implementations described herein provide a computer system for managing carbon emissions in cloud computing environments. For example, the computer system may receive server data identifying a plurality of server devices and factors that influence carbon emissions of the plurality of server devices, and may calculate, for each of the plurality of server devices, carbon credits to execute a unit of work at different time periods, where the carbon credits to execute the unit of work at different time periods form a plurality of carbon credits associated with the plurality of server devices. The computer system may generate an ordered data structure that arranges identifiers of the plurality of server devices based on the plurality of carbon credits, and may utilize the ordered data structure to select one of the plurality of server devices with a quantity of carbon credits to process requests generated by an application for a time period.

In this way, the computer system manages carbon emissions in cloud computing environments. For example, the computer system may provide a technique for cloud server devices to schedule applications based on an application's carbon credit limit and on carbon credits required by the application for a time period (e.g., the rest of the day). The computer system may optimize resource allocation and load balancing across server devices, thus reducing server device utilization and associated energy consumption. By dynamically updating an ordered data structure based on changing server device loads, availabilities, and carbon emissions, the computer system may efficiently manage server device resources and may minimize the risk of server device overload and associated performance degradation. Thus, the computer system may reduce heat generated by the object storage system, may increase utilization of renewable energy sources, and may minimize the need for excessive cooling and energy consumption in the object storage system. Thus, the computer system conserves computing resources, networking resources, and/or the like that would otherwise have been consumed by failing to process future requests of an application, handling customer complaints associated with handling future requests of an application, utilizing server devices incapable of processing request of an application while satisfying sustainability goals, and/or the like.

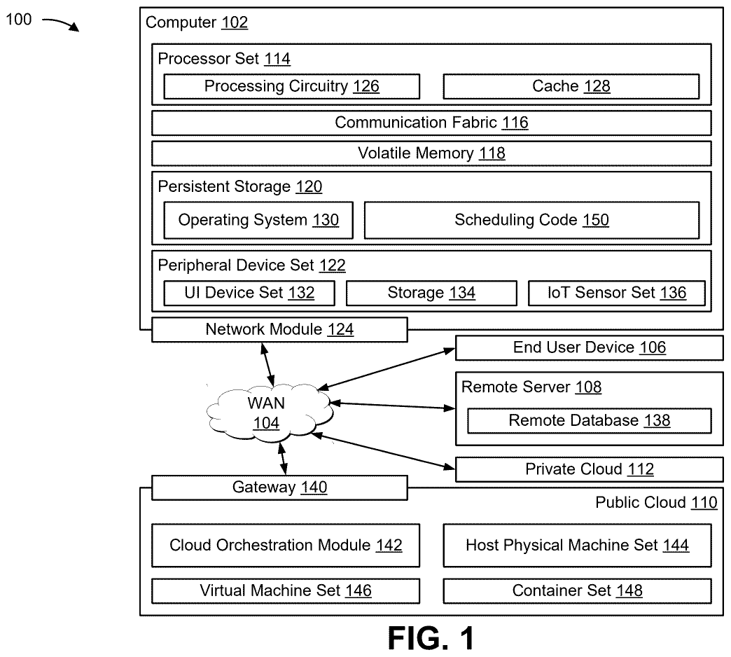

FIG. 1 is a diagram of an example computing environment 100 for managing carbon emissions in cloud computing environments, as described herein.

Computing environment 100 contains an example of an environment for the execution of at least some of the computer code involved in performing the inventive methods, such as scheduling code 150 (e.g., code for managing carbon emissions in cloud computing environments). In addition to scheduling code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and scheduling code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in scheduling code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

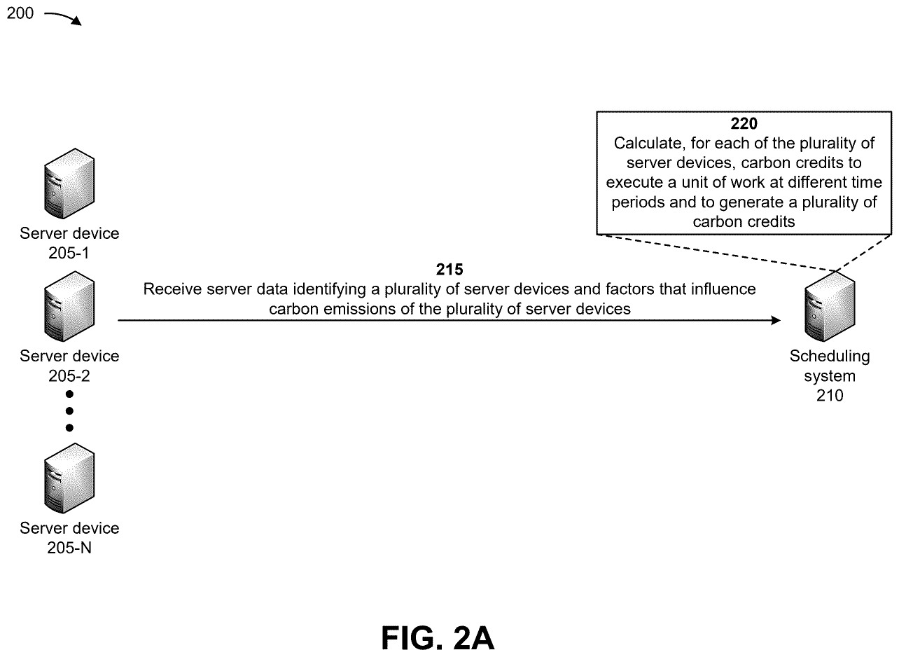

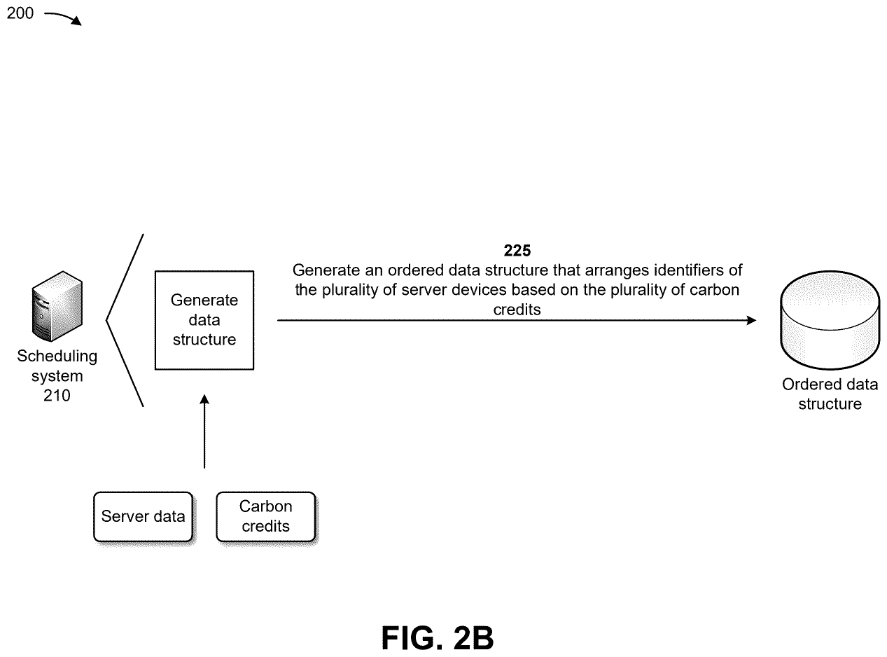

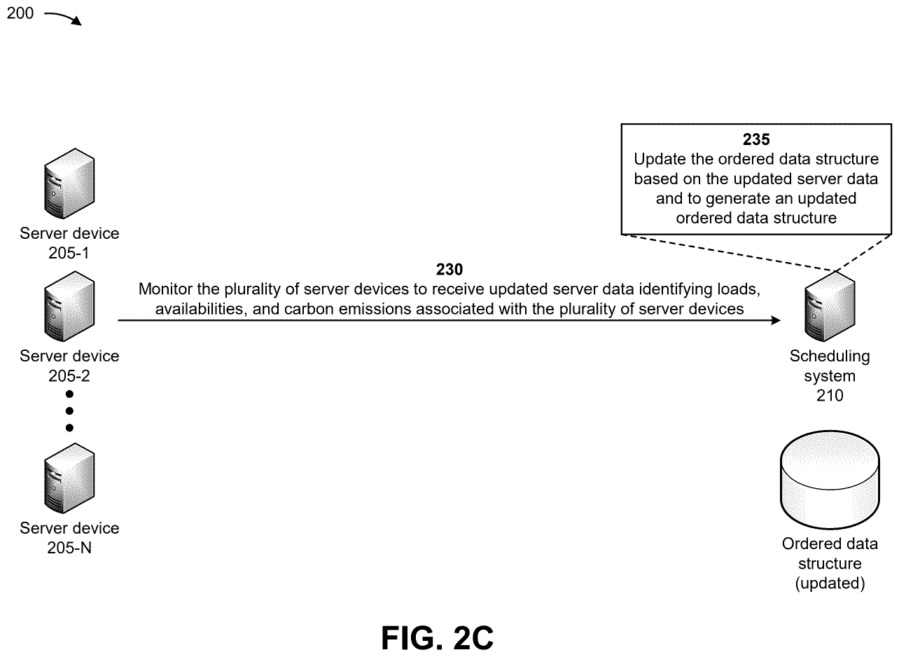

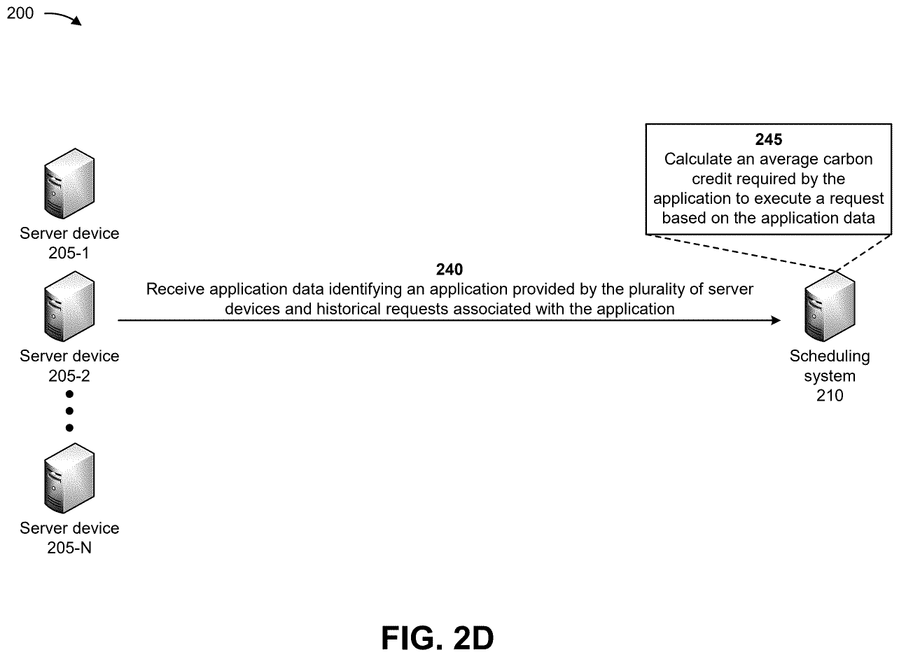

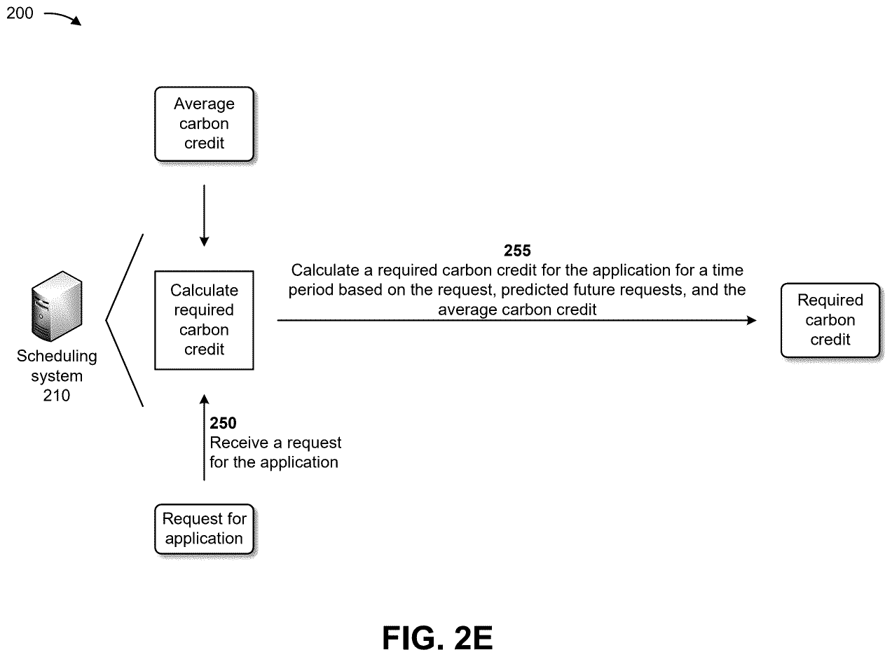

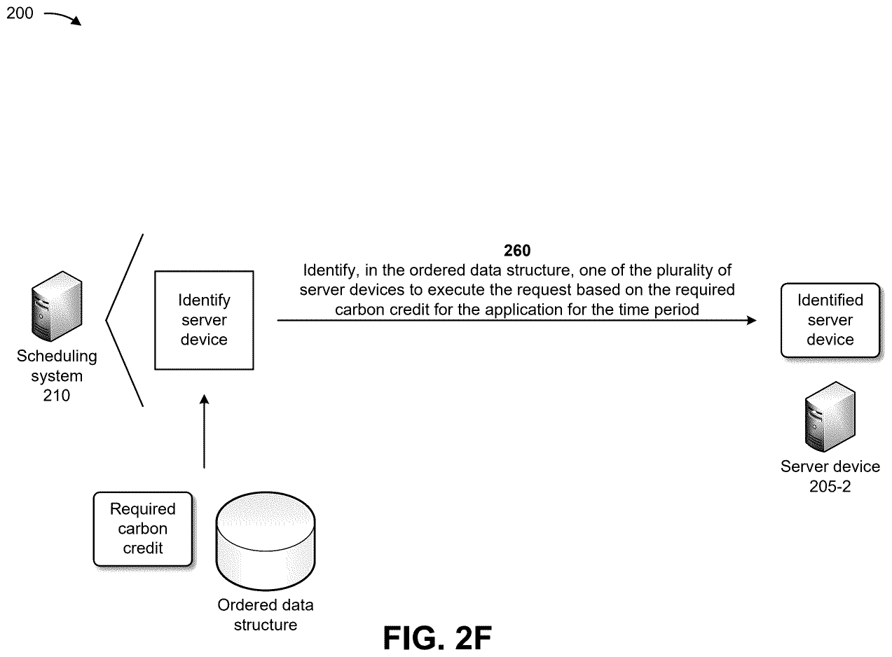

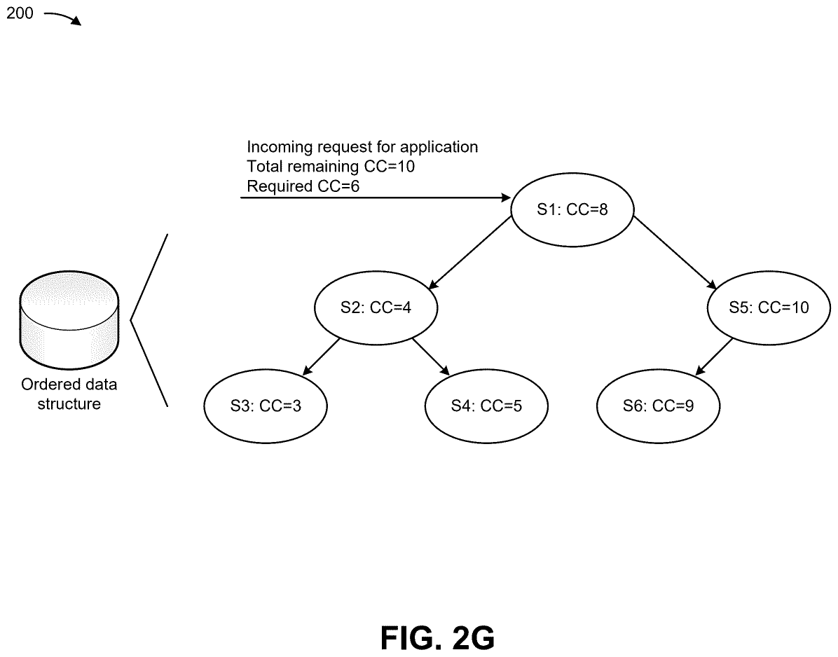

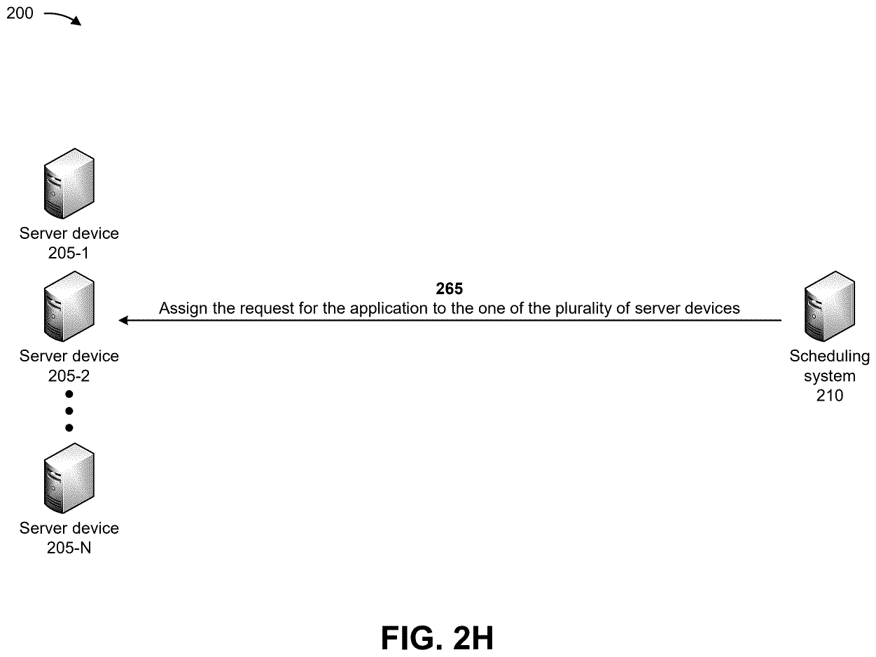

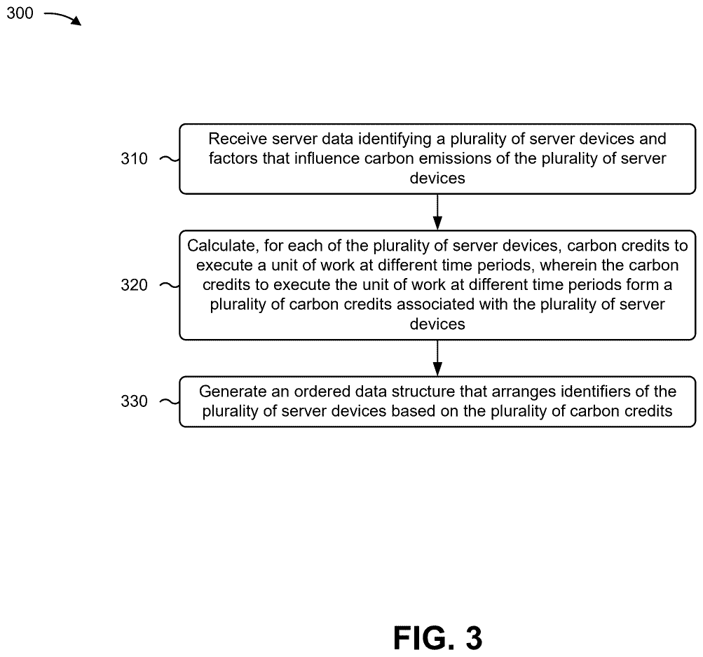

The code included in the scheduling code 150 typically includes at least some of the computer code involved in performing one or more operations described herein, such as the operations of implementation 200 in FIGS. 2A-2H and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2H are diagrams of an example 200 associated with managing carbon emissions in cloud computing environments. As shown in FIGS. 2A-2H, the example 200 includes a plurality of server devices 205 (e.g., server device nodes 205-1 through 205-N) associated with a scheduling system 210. Each of the plurality of server devices 205 and the scheduling system 210 may correspond to the computer 102, the remote server 108, a system provided by the public cloud 110, and/or a system provided by the private cloud 112. Further details of the plurality of server devices 205 and the scheduling system 210 are provided elsewhere herein.

As shown in FIG. 2A, and by reference number 215, the scheduling system 210 may receive server data identifying a plurality of server devices 205 and factors that influence carbon emissions of the plurality of server devices 205. For example, the scheduling system 210 may receive the server data identifying the plurality of server devices 205 and the factors that influence the carbon emissions of the plurality of server devices 205 from various sources. In some implementations, each server device 205 may be configured to collect and transmit its own server data to the scheduling system 210. The server data may include server device identification information (e.g., a network address, a server name, and/or a location), hardware specifications (e.g., a processor type, a memory type, and/or a storage type), and current operational status (e.g., a workload, a temperature, and/or a power consumption). Alternatively, or additionally, the scheduling system 210 may deploy monitoring agents on each server device 205 to collect data on various parameters, such as processor utilization, memory usage, disk space, network traffic, power consumption, and/or the like. Alternatively, or additionally, the scheduling system 210 may integrate with existing server management systems to collect the server data and the factors that influence the carbon emissions of the plurality of server devices 205. Alternatively, or additionally, the scheduling system 210 may receive the server data from a cloud provider's management application programming interfaces (APIs).

In some implementations, the factors that influence the carbon emissions of the plurality of server devices 205 may include power sources of the plurality of server devices 205, locations of the plurality of server devices 205, ages and efficiencies of the plurality of server devices 205, cooling systems of the plurality of server devices 205, workloads and utilizations of the plurality of server devices 205, and/or the like. For example, the scheduling system 210 may receive data on the power sources used by each server device 205, such as renewable energy sources (e.g., solar or wind), non-renewable energy sources (e.g., coal or natural gas), or a mix of both. The scheduling system 210 may receive data on the geographical location of each server device 205, which can affect carbon emissions due to varying regional energy mixes and cooling requirements. The scheduling system 210 may receive data on the age and efficiency of each server device 205, which can impact carbon emissions due to varying energy consumption patterns. The scheduling system 210 may receive data on the cooling systems used by each server device 205, such as air cooling, water cooling, or advanced cooling systems. The scheduling system 210 may receive data on the workload and utilization patterns of each server device 205, which can affect carbon emissions due to varying energy consumption patterns.

The server data and the factors influencing carbon emissions may be received by the scheduling system 210 using various communication protocols, such as APIs provided for the plurality of server devices 205, message queues, file transfers, and/or the like. In some implementations, the scheduling system 210 may continuously receive the server data identifying the plurality of server devices 205 and the factors that influence the carbon emissions, may periodically receive the server data identifying the plurality of server devices 205 and the factors that influence the carbon emissions, may receive the server data identifying the plurality of server devices 205 and the factors that influence the carbon emissions based on requesting the server data and the factors, and/or the like. In some implementations, the scheduling system 210 may store the received data in a database or data warehouse, such as a relational database management system (RDBMS) or a structured query language (SQL) database, for further processing and analysis.

As further shown in FIG. 2A, and by reference number 220, the scheduling system 210 may calculate, for each of the plurality of server devices 205, carbon credits to execute a unit of work at different time periods and to generate a plurality of carbon credits associated with the plurality of server devices 205. For example, the scheduling system 210 may calculate carbon credits for each of the plurality of server devices 205 by considering various factors that influence carbon emissions, such as power sources, server efficiency, cooling systems, and workload utilization. The scheduling system 210 may estimate the power consumption of each server device 205 based on its specifications, workload, and utilization patterns. For example, the scheduling system 210 may utilize power modeling techniques, such as linear regression or machine learning models, that take into account various parameters, such as processor utilization, memory usage, and storage access patterns, to estimate the power consumption.

The scheduling system 210 may calculate the carbon emissions associated with each server device 205 based on its power consumption and a carbon intensity of the power source utilized to generate the power. Carbon intensity is typically measured in grams of carbon dioxide equivalent per kilowatt-hour (kWh). The scheduling system 210 may utilize publicly available data sources to obtain carbon intensity values for different power sources. The scheduling system 210 may assign a carbon credit value to each server device 205 based on its calculated carbon emissions. A carbon credit may represent a right to emit a certain amount of greenhouse gases, such as carbon dioxide. The scheduling system 210 may utilize standardized carbon credit protocols, such as the clean development mechanism (CDM) or the verified carbon standard (VCS), to ensure consistency and accuracy in carbon credit calculations. The scheduling system 210 may calculate carbon credits for each server device 205 for different time periods, such as an hour, a day, a week, a month, or a year. This may enable the scheduling system 210 to capture variations in power consumption and carbon emissions over time.

The scheduling system 210 may consider other factors that influence carbon emissions, such as server efficiency (e.g., more efficient servers may receive more carbon credits for the same workload, cooling systems (e.g., servers with more efficient cooling systems may receive more carbon credits for the same workload), workload utilization (e.g., servers with higher workload utilization may receive more carbon credits for the same time period), power sources (e.g., servers powered by renewable energy sources may receive more carbon credits for the same workload), and/or the like. In some implementations, the scheduling system 210 may utilize predictions, such as workload predictions of each server device 205, weather predictions, and/or the like, to calculate carbon emissions for each server device 205 for different time periods in order to accommodate dynamic factors that influence carbon emission. For example, the scheduling system 210 may utilize a machine learning model, such as a long short-term memory (LSTM) model, a support vector regression (SVR) model, and/or the like, to determine future workload predictions for each server device 205.

A carbon credit, also known as, a carbon offset, is a tradeable permit representing a right to emit an amount (e.g., one ton) of carbon dioxide or an equivalent amount of another greenhouse gas (GHG). The scheduling system 210 may allocate a plurality of carbon credits to the plurality of server devices 205 by allocating carbon credits for each server device 205 and each time period. In some implementations, the scheduling system 210 may store the plurality of carbon credits allocated to the plurality of server devices 205 in a database or data warehouse for further processing and analysis.

As shown in FIG. 2B, and by reference number 225, the scheduling system 210 may generate an ordered data structure that arranges identifiers of the plurality of server devices 205 based on the plurality of carbon credits. For example, the scheduling system 210 may generate the ordered data structure that arranges the identifiers of the plurality of server devices 205 based on the plurality of carbon credits by utilizing a combination of models and data structures. In some implementations, the scheduling system 210 may retrieve the server data and the plurality of carbon credits associated with the plurality of server devices 205 as calculated by the scheduling system 210. The scheduling system 210 may preprocess the retrieved data to ensure that the retrieved data is in a suitable format for generating the ordered data structure. This may include normalizing the plurality of carbon credits to a common scale, removing any missing or duplicate values, transforming the data into a format that can be easily sorted and compared, and/or the like.

The scheduling system 210 may utilize a sorting model to arrange the plurality of server devices 205 based on the plurality of carbon credits associated with the plurality of server devices 205. The sorting model may include a quick sort model (e.g., a divide-and-conquer model that sorts the data by recursively partitioning the data around a pivot element), a merge sort model (e.g., a divide-and-conquer model that sorts the data by merging smaller sorted arrays into a larger sorted array), a heap sort model (e.g., a comparison-based model that sorts the data by building a heap and repeatedly removing the smallest (or largest) element), and/or the like. The scheduling system 210 may store the sorted data (e.g., the identifiers of the plurality of server devices 205 arranged based on the plurality of carbon credits) in an ordered data structure that allows for efficient retrieval and updating of the data. In some implementations, the ordered data structure may include a balanced binary search tree (BBST), which is a self-balancing data structure that stores the identifiers of the plurality of server devices 205 as sorted nodes (e.g., based on the plurality of carbon credits available to the plurality of server devices 205), with each node having at most two children. Alternatively, the ordered data structure may include an array, which is a contiguous block of memory that stores the identifiers of the plurality of server devices 205 in a sorted order. Alternatively, the ordered data structure may include a linked list, which is a dynamic data structure that stores the identifiers of the plurality of server devices 205 in a sorted order, with each element pointing to the next element in the list.

The scheduling system 210 may create an index for the ordered data structure in order to enable fast lookup and retrieval of the identifiers of the plurality of server devices 205. The index may include a B-tree index that stores keys (e.g., the identifiers of the plurality of server devices 205) in a sorted order, with each node having a fixed number of children. Alternatively, the index may include a hash table that maps keys (e.g., the identifiers of the plurality of server devices 205) to values (e.g., the plurality of carbon credits) using a hash function.

In some implementations, the scheduling system 210 may generate the ordered data structure as a table or a graph, with each server device 205 being represented by a unique identifier. The scheduling system 210 may construct the ordered data structure by sorting the identifiers of the plurality of server devices 205 based on the plurality of carbon credits associated with the plurality of server devices 205. The server devices 205 with the lowest carbon credits may be provided at the top of the ordered data structure, while the server devices 205 with the highest carbon credits may be provided at the bottom of the ordered data structure. In this way, the scheduling system 210 may utilize the ordered data structure to select the server device 205 with the lowest carbon credits to execute a workload.

As shown in FIG. 2C, and by reference number 230, the scheduling system 210 may monitor the plurality of server devices 205 to receive updated server data identifying loads, availabilities, and carbon emissions associated with the plurality of server devices 205. For example, the scheduling system 210 may monitor the plurality of server devices 205, and may receive the updated server data identifying loads, availabilities, and carbon emissions associated with the plurality of server devices 205 based on monitoring the plurality of server devices 205. In some implementations, the scheduling system 210 may utilize various monitoring tools to collect updated server data from the plurality of server devices 205. For example, the scheduling system 210 may utilize software agents that are installed on each server device 205 to collect and transmit the updated server data to the scheduling system 210, or may utilize simple network management protocol (SNMP) monitors to collect updated server data from the plurality of server devices 205. The scheduling system 210 may utilize API calls to the server devices 205 to collect updated server data, or may perform an analysis of log files generated by the server devices 205 to collect updated server data. The scheduling system 210 may utilize various monitoring techniques to collect the updated server data from the plurality of server devices 205. These techniques may include polling (where the scheduling system 210 may poll the server devices 205 at regular intervals to collect updated server data), push-based monitoring (where the server devices 205 may push updated server data to the scheduling system 210), or event-driven monitoring (where the scheduling system 210 may receive notifications from the server devices 205 when specific events occur, such as changes in load or availability).

In some implementations, the updated server data may include data indicating the current load on each server device 205, such as processor utilization, memory usage, and disk usage. The updated server data may include data indicating current availability of each server device 205, such as whether the server device is online or offline. The updated server data may include data indicating current carbon emissions associated with each server device 205, such as the amount of energy consumed by the server device. In some implementations, the scheduling system 210 may update the plurality of carbon credits associated with the plurality of server devices 205 based on the updated server data. For example, the scheduling system 210 may reduce the quantity of carbon credits for one server device 205 based on the updated server data, and may increase the quantity of carbon credits for another server device 205 based on the updated server data.

As further shown in FIG. 2C, and by reference number 235, the scheduling system 210 may update the ordered data structure based on the updated server data and to generate an updated ordered data structure. For example, the scheduling system 210 may utilize various models and data structures to update the ordered data structure based on the updated server data and to generate the updated ordered data structure. In some implementations, the scheduling system 210 may utilize a binary search tree to update the ordered data structure based on the updated server data. The scheduling system 210 may traverse the binary search tree to locate a position of each server device 205 in the ordered data structure, based on the updated carbon credits for the server device 205. If the updated carbon credits of a server device 205 have changed, an identifier of the server device 205 may be moved to a new position in the binary search tree. Alternatively, or additionally, the scheduling system 210 may utilize a balanced binary search tree to update the ordered data structure based on the updated server data. The balanced binary search tree may be self-balancing, ensuring that the tree remains approximately balanced after insertions or deletions. Alternatively, or additionally, the scheduling system 210 may utilize a heap data structure to update the ordered data structure based on the updated server data. The heap may be updated by adding or removing identifiers of server devices 205, or by modifying the carbon credits of existing identifiers of server devices 205. After updating the ordered data structure, the scheduling system 210 may generate an updated ordered data structure that reflects the current state of the plurality of server devices 205. The updated ordered data structure may be used to select one of the plurality of server devices 205 with carbon credits to process requests generated by an application for a time period.

As shown in FIG. 2D, and by reference number 240, the scheduling system 210 may receive application data identifying an application provided by the plurality of server devices 205 and historical requests associated with the application. For example, the scheduling system 210 may receive the application data identifying the application provided by the plurality of server devices 205 and the historical requests from various sources. In some implementations, the scheduling system 210 may receive the application data and the historical request from application management systems, such as application servers, load balancers, or application delivery controllers. These systems may provide information about the application, such as its name, type, and requirements. Alternatively, or additionally, the scheduling system 210 may receive the application data and the historical requests from server logs, which may include information about the requests, such as a request type, a timestamp, and resource usage. Alternatively, or additionally, the scheduling system 210 may receive the application data and the historical requests from monitoring agents installed on each server device 205, which periodically collect and transmit data about the application, such as its performance, resource usage, and request patterns. Alternatively, or additionally, the scheduling system 210 may receive the application data and the historical requests through API calls to the application or the server devices 205, which may provide information about the application, such as its configuration, usage patterns, and performance metrics. Alternatively, or additionally, the scheduling system 210 may receive the application data and the historical requests from database systems, which may store historical request data, application configuration data, and other relevant information.

In some implementations, the application data may include metadata about the application (e.g., a name, type, version, and requirements), data about the request patterns of the application (e.g., frequency, duration, and type of requests), data about the resource usage of the application (e.g., processor, memory, and storage usage), performance metrics about the application (e.g., response times, throughput, and latency), historical request data (e.g., timestamped records of requests, responses, and errors), and/or the like. The scheduling system 210 may receive the application data and the historical request data through various interfaces and protocols, such as RESTful APIs (e.g., that provide a standardized interface for data exchange), GraphQL APIs (e.g., that provide a flexible and efficient interface for data exchange), message queues, file transfers (e.g., which provide a secure interface for data exchange), and/or the like.

As further shown in FIG. 2D, and by reference number 245, the scheduling system 210 may calculate an average carbon credit required by the application to execute a request based on the application data. For example, the scheduling system 210 may calculate the average carbon credit required by the application to execute a request by analyzing the application data. In some implementations, the scheduling system 210 may analyze the request patterns of the application, such as the frequency, duration, and type of requests. Alternatively, or additionally, the scheduling system 210 may analyze the resource usage of the application, such as processor, memory, and storage usage. Alternatively, or additionally, the scheduling system 210 may analyze performance metrics about the application, such as response times, throughput, and latency. Alternatively, or additionally, the scheduling system 210 may analyze historical request data, such as timestamped records of requests, responses, and errors.

The scheduling system 210 may calculate processor, memory, and other resources required by the application to execute a request using various models and techniques. In some implementations, the scheduling system 210 may utilize linear regression to model the relationship between the request patterns and resource usage. Alternatively, or additionally, the scheduling system 210 may utilize decision trees to classify requests into different categories based on their resource usage. Alternatively, or additionally, the scheduling system 210 may utilize clustering models to group similar requests together based on their resource usage. Alternatively, or additionally, the scheduling system 210 may utilize a machine learning model, such as a neural network or a support vector machine, to predict the processor, memory, and other resources required by the application to execute a request.

In some implementations, the scheduling system 210 may estimate the processor, memory, and other resources required by the application to execute a request based on the analysis of the application data. For example, the scheduling system 210 may calculate the average resource usage of the application over a certain period of time, and may calculate the average carbon emissions of the application over a certain period of time. The scheduling system 210 may calculate the frequency of requests made by the application over a certain period of time, and may calculate the average duration of requests made by the application over a certain period of time. In some implementations, the scheduling system 210 may assign the estimated average carbon credit to each request made by the application. The assigned carbon credit may be used by the scheduling system 210 to schedule requests made by the application, to allocate resources to the application, to monitor the performance of the application, and/or the like.

In some implementations, the scheduling system 210 may utilize historical learning to calculate the average carbon credit required by the application to execute a request. The carbon credit required by the application to execute a request may vary for different server devices 205 and for different time periods, hence a median of carbon credit required by the application to execute a request may be considered. In some implementations, each application may register its carbon credit limit with the scheduling system 210. This registration may include setting daily or monthly carbon limits based on the implementation strategy of the scheduling system 210. By doing so, the scheduling system 210 may ensure that each application operates within its allocated carbon credits, thereby promoting efficient resource utilization and adherence to sustainability goals.

As shown in FIG. 2E, and by reference number 250, the scheduling system 210 may receive a request for the application. For example, the scheduling system 210 may receive the request for the application from various sources, such as from end-user devices (e.g., smartphones, laptops, or tablets), from other applications (e.g., web services, APIs, or microservices), from network devices (e.g., routers, switches, or firewalls), from server devices (e.g., web servers, database servers, or file servers), and/or the like. In some implementations, the request for the application may include various content, such as request headers that contain metadata about the request (e.g., the request method and authentication information), a request body that contains the payload of the request (e.g., data, files, or other content), query parameters that contain additional metadata about the request (e.g., filtering criteria or pagination information), authentication credentials (e.g., usernames, passwords, or access tokens) that are used to authenticate the request, and/or the like. Upon receiving the request for the application, the scheduling system 210 may perform various processing tasks. For example, the scheduling system 210 may authenticate the request using various mechanisms, such as authentication credentials, access tokens, or biometric authentication. The scheduling system 210 may authorize the request using various mechanisms, such as role-based access control, attribute-based access control, or claims-based access control. The scheduling system 210 may validate the request using various mechanisms, such as input validation, data validation, or business rules validation. The scheduling system 210 may log the request using various mechanisms, such as logging frameworks, log files, or log databases.

As further shown in FIG. 2E, and by reference number 255, the scheduling system 210 may calculate a required carbon credit for the application for a time period based on the request, predicted future requests, and the average carbon credit. For example, the scheduling system 210 may calculate the required carbon credit for the application for a time period by considering the following factors. The scheduling system 210 may analyze the characteristics of the request, such as the request type, duration, and resource usage. The scheduling system 210 may utilize predictive models to forecast future requests for the application, taking into account factors such as seasonal patterns, historical request data, trends, and fluctuations in demand. The scheduling system 210 may also utilize the average carbon credit required by the application to execute a request, as described above. In some implementations, the scheduling system 210 may calculate the required carbon credit for the application for a time period using various models and techniques. For example, the scheduling system 210 may utilize linear regression to model the relationship between the request characteristics, the predicted future requests, and the average carbon credit, and may calculate the required carbon credit for the application for the time period based on the relationship. Alternatively, or additionally, the scheduling system 210 may utilize time series analysis to forecast future carbon credit requirements based on historical data and trends, and may calculate the required carbon credit for the application for the time period based on the forecasted future carbon credit requirements. Alternatively, or additionally, the scheduling system 210 may utilize a machine learning model, such as a neural network or a decision tree, to predict the required carbon credit based on the request characteristics, the predicted future requests, and the average carbon credit.

The scheduling system 210 may calculate the total required carbon credit for the application for the time period by multiplying the average carbon credit required by the application to execute a request by the total number of requests predicted for the time period. In some implementations, the scheduling system 210 may allocate the required carbon credit to the application for the time period. For example, the scheduling system 210 may reserve the required carbon credit for the application for the time period, and may allocate the reserved carbon credit to the application for the time period. By calculating the required carbon credit for the application for the time period, the scheduling system 210 may ensure that the application has a quantity of carbon credits to execute requests and minimize its carbon footprint.

As shown in FIG. 2F, and by reference number 260, the scheduling system 210 may identify, in the ordered data structure, one of the plurality of server devices 205 to execute the request based on the required carbon credit for the application for the time period. For example, the scheduling system 210 may search the ordered data structure to identify one of the plurality of server devices 205 that has a quantity of carbon credits to execute the request. The scheduling system 210 may utilize a binary search model to quickly locate a server device 205 with a quantity of carbon credits in the ordered data structure. Alternatively, the scheduling system 210 may utilize a linear search model to examine each server device 205 in the ordered data structure and determine if it has a quantity of carbon credits to execute the request. Alternatively, the scheduling system 210 may utilize a hashing function to quickly locate a server device 205 with a quantity of carbon credits in the ordered data structure.

In some implementations, the scheduling system 210 may select one of the plurality of server devices 205 to execute the request based on various criteria, such as carbon credit availability. For example, the scheduling system 210 may select a server device 205 that has a quantity of carbon credits to execute the request. Alternatively, or additionally, the scheduling system 210 may select a server device 205 that has a low load or utilization rate to ensure efficient execution of the request. Alternatively, or additionally, the scheduling system 210 may select a server device 205 that is geographically close to a user of the application to minimize latency and network communication overhead. If multiple server devices 205 have the same amount of available carbon credits, the scheduling system 210 may utilize tie-breaking criteria, such as server device priority (e.g., the scheduling system 210 may assign a priority to each server device 205 based on its performance, reliability, or other factors), server device cost (e.g., the scheduling system 210 may consider the cost of using each server device 205, such as energy consumption or maintenance costs), server device utilization history (e.g., the scheduling system 210 may analyze the utilization history of each server device 205 to predict its future availability and performance), and/or the like.

In some implementations, the scheduling system 210 may utilize a binary search tree model to identify, in the ordered data structure, one of the plurality of server devices 205 to execute the request based on the required carbon credit for the application for the time period. For example, the scheduling system 210 may initially identify a root node (e.g., a server device 205) of the binary search tree. If the scheduling system 210 determines that a remaining carbon credit (e.g., after assignment to the identified server device 205) is greater than or equal to the required carbon credit for the application for the time period (e.g., indicating that enough carbon credits are available for the time period), the scheduling system 210 may move to a right child node of the root node and may identify the right child node as the server device 205 to execute the request. Alternatively, if the scheduling system 210 determines that a remaining carbon credit (e.g., after assignment to the identified server device 205) is less than the required carbon credit for the application for the time period, the scheduling system 210 may move to a left child node of the root node, if there is a left child node (e.g., indicating that a node with lesser carbon emission needs to be identified because the application will not have enough carbon credits for the time period). The scheduling system 210 may iteratively perform these two steps until an identified node does not have any descendant nodes.

If the scheduling system 210 determines that a remaining carbon credit (e.g., for a current node) is greater than or equal to the required carbon credit for the application for the time period, then the scheduling system 210 may assign the request to the current node (e.g., a first server device 205). If the scheduling system 210 determines that a remaining carbon credit (e.g., for a current node) is less than the required carbon credit for the application for the time period and a left traversal was performed to reach the current node, than the scheduling system 210 may assign the request to the current node (e.g., the first server device 205) and may generate a warning indicating that there are not enough carbon credits for the time period. If the scheduling system 210 determines that a remaining carbon credit (e.g., for a current node) is less than the required carbon credit for the application for the time period and a right traversal was performed to reach the current node, than the scheduling system 210 may assign the request to a parent node (e.g., a second server device 205) of the current node. In some implementations, the method explained in the above example may perform an assignment of the request with a log time complexity. In some implementations, if there is a node (e.g., a server device 205) that cannot handle more load or is overloaded, then the scheduling system 210 may dynamically remove the node from the binary search tree and may add the node back to the binary search tree when the node has enough capacity to handle more load.

FIG. 2G depicts an example of nodes provided in an ordered data structure. As shown, the ordered data structure may include a root node representing a first server device 205 (S1) with eight (8) carbon credits (CC), a node representing a second server device 205 (S2) with four (4) CC, a node representing a third server device 205 (S3) with three (3) CC, a node representing a fourth server device 205 (S4) with three (3) CC, a node representing a fifth server device 205 (S5) with ten (10) CC, and a node representing a sixth server device 205 (S6) with nine (9) CC. As further shown in FIG. 2G, an incoming request for an application may include ten (10) remaining carbon credits and may require six (6) carbon credits. Utilizing the binary tree methodology described above in connection with FIG. 2F, the scheduling system 210 may assign the incoming request to the second server device 205 (S2).

As shown in FIG. 2H, and by reference number 265, the scheduling system 210 may assign the request for the application to the one of the plurality of server devices 205. For example, the scheduling system 210 may assign the request for the application to the one of the plurality of server devices 205 by forwarding the request to the selected server device 205 for processing, by notifying the selected server device 205 that it has been assigned to process the request, or by queuing the request in a request queue associated with the selected server device 205. In some implementations, the scheduling system 210 may utilize an assignment model to determine which server device 205 should process the request. The assignment model may consider various factors, such as the availability of each server device 205 (e.g., processing capacity, memory, and storage), the load on each server device 205 (e.g., a number of requests it is currently processing and its utilization rate), a priority of the request (e.g., its urgency and importance), and/or the like.

Once the request has been assigned to the server device 205, the server device 205 may process the request. The processing may include executing the request (e.g., executing the application, processing data, or storing data), and completing the request (e.g., returning results or storing data in a database). The scheduling system 210 may track the request throughout a lifecycle of the request, including request assignment to a server device 205, processing by the server device 205, and completion.

In this way, the computer system (e.g., the scheduling system 210) manages carbon emissions in cloud computing environments. For example, the computer system may provide a technique for cloud server devices to schedule applications based on an application's carbon credit limit and on carbon credits required by the application for a time period (e.g., the rest of the day). The computer system may optimize resource allocation and load balancing across server devices, thus reducing server device utilization and associated energy consumption. By dynamically updating an ordered data structure based on changing server device loads, availabilities, and carbon emissions, the computer system may efficiently manage server device resources and may minimize the risk of server device overload and associated performance degradation. Thus, the computer system may reduce heat generated by the object storage system, may increase utilization of renewable energy sources, and may minimize the need for excessive cooling and energy consumption in the object storage system. Thus, the computer system conserves computing resources, networking resources, and/or the like that would otherwise have been consumed by failing to process future requests of an application, handling customer complaints associated with handling future requests of an application, utilizing server devices incapable of processing request of an application while satisfying sustainability goals, and/or the like.

As indicated above, FIGS. 2A-2H are provided as an example. Other examples may differ from what is described with regard to FIGS. 2A-2H. The number and arrangement of devices shown in FIGS. 2A-2H are provided as an example. In practice, there may be additional devices, fewer devices, different devices, or differently arranged devices than those shown in FIGS. 2A-2H. Furthermore, two or more devices shown in FIGS. 2A-2H may be implemented within a single device, or a single device shown in FIGS. 2A-2H may be implemented as multiple, distributed devices. Additionally, or alternatively, a set of devices (e.g., one or more devices) shown in FIGS. 2A-2H may perform one or more functions described as being performed by another set of devices shown in FIGS. 2A-2H.

FIG. 3 is a flowchart of an example process 300 associated with managing carbon emissions in cloud computing environments. One or more process blocks of FIG. 3 are performed by a computer system (e.g., the computer 102 and/or the scheduling system 210) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or scheduling code 150.

As shown in FIG. 3, process 300 may include receiving server data identifying a plurality of server devices and factors that influence carbon emissions of the plurality of server devices (block 310). For example, the computer system may receive server data identifying a plurality of server devices and factors that influence carbon emissions of the plurality of server devices, as described above. In some implementations, the factors that influence carbon emissions of the plurality of server devices include one or more of power sources of the plurality of server devices, ages of the plurality of server devices, geographical locations of the plurality of server devices, or cooling systems of the plurality of server devices.

As further shown in FIG. 3, process 300 may include calculating, for each of the plurality of server devices, carbon credits to execute a unit of work at different time periods, wherein the carbon credits to execute the unit of work at different time periods form a plurality of carbon credits associated with the plurality of server devices (block 320). For example, the computer system may calculate, for each of the plurality of server devices, carbon credits to execute a unit of work at different time periods, as described above. In some implementations, the carbon credits to execute the unit of work at different time periods may form a plurality of carbon credits associated with the plurality of server devices. In some implementations, each of the different time periods includes one of an hour, a day, a week, a month, or a year.

As further shown in FIG. 3, process 300 may include generating an ordered data structure that arranges identifiers of the plurality of server devices based on the plurality of carbon credits (block 330). For example, the computer system may generate an ordered data structure that arranges identifiers of the plurality of server devices based on the plurality of carbon credits, as described above.

In some implementations, process 300 includes monitoring the plurality of server devices, receiving, based on monitoring the plurality of server devices, updated server data identifying loads, availabilities, and carbon emissions associated with the plurality of server devices, and updating the ordered data structure based on the updated server data and to generate an updated ordered data structure.

In some implementations, process 300 includes receiving application data identifying an application provided by the plurality of server devices and historical requests associated with the application, and calculating an average of resources required by the application based on the application data. In some implementations, process 300 includes receiving a request for the application, calculating a required carbon credit for the application for a time period based on the request, predicted future requests, and the average of resources required by the application, and identifying, in the ordered data structure, one of the plurality of server devices to execute the request based on the required carbon credit for the application for the time period. In some implementations, process 300 includes assigning the request for the application to the one of the plurality of server devices. In some implementations, the one of the plurality of server devices is configured to process the request and future requests for the time period. In some implementations, calculating the required carbon credit for the application for the time period includes calculating the required carbon credit for the application for the time period based on historical data associated with the application.

In some implementations, process 300 includes utilizing the ordered data structure to select one of the plurality of server devices with a quantity of carbon credits to process requests generated by an application for a time period. In some implementations, utilizing the ordered data structure to select the one of the plurality of server devices includes utilizing a binary search tree model with the ordered data structure to select the one of the plurality of server devices. In some implementations, utilizing the ordered data structure to select the one of the plurality of server devices includes traversing through the ordered data structure based on predetermined conditions to select the one of the plurality of server devices. In some implementations, process 300 includes generating a warning if there is not a quantity of carbon credits for the one of the plurality of server devices to process the requests generated by the application for the time period.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method comprising:
receiving, by a computer system, server data identifying a plurality of server devices and factors that influence carbon emissions of the plurality of server devices;
calculating, by the computer system, for each server device of the plurality of server devices and for each time period of a plurality of different time periods, a respective carbon credit value for the server device to execute a unit of work during the time period, wherein calculating the respective carbon credit value includes calculating carbon emissions attributable to execution of the unit of work by the server device during the time period based on an estimated power consumption of the server device and a carbon intensity of a power source utilized to generate power for the server device;
assigning, by the computer system, for each server device and each time period, the respective carbon credit value to the server device for the time period based on the calculated carbon emissions; and
generating, by the computer system, an ordered data structure that, for a given time period of the plurality of different time periods, arranges identifiers of the plurality of server devices according to the respective carbon credit value assigned to each server device for the given time period.

2. The method of claim 1, further comprising:
monitoring, by the computer system, the plurality of server devices;
receiving, by the computer system, based on monitoring the plurality of server devices, updated server data identifying loads, availabilities, and carbon emissions associated with the plurality of server devices; and
updating, by the computer system, the ordered data structure based on the updated server data to generate an updated ordered data structure.

3. The method of claim 1, further comprising:
receiving, by the computer system, application data identifying an application provided by the plurality of server devices and historical requests associated with the application; and
calculating, by the computer system, an average of resources required by the application based on the application data.

4. The method of claim 3, further comprising:
receiving, by the computer system, a request for the application;
calculating, by the computer system, a required carbon credit for the application for the given time period based on the request, predicted future requests, and the average of resources required by the application; and
identifying, by the computer system, in the ordered data structure, one of the plurality of server devices to execute the request based on the required carbon credit for the application for the given time period.

5. The method of claim 4, further comprising:
assigning, by the computer system, the request for the application to the one of the plurality of server devices.

6. The method of claim 5, wherein the one of the plurality of server devices is configured to process the request and the predicted future requests for the given time period.

7. The method of claim 4, wherein calculating the required carbon credit for the application for the given time period comprises:
calculating the required carbon credit for the application for the given time period based on historical data associated with the application.

8. A computer system, comprising:
a processor set;
one or more computer-readable storage media; and
program instructions stored on the one or more computer-readable storage media to cause the processor set to perform operations comprising:
receiving server data identifying a plurality of server devices and factors that influence carbon emissions of the plurality of server devices;
calculating, for each server device of the plurality of server devices and for each time period of a plurality of different time periods, a respective carbon credit value for the server device to execute a unit of work, during the time period, wherein calculating the respective carbon credit value includes calculating carbon emissions attributable to execution of the unit of work by the server device during the time period based on an estimated power consumption of the server device and a carbon intensity of a power source utilized to generate power for the server device;
assigning, for each server device and each time period, the respective carbon credit value to the server device for the time period based on the calculated carbon emissions;
generating an ordered data structure that, for a given time period of the plurality of different time periods, arranges identifiers of the plurality of server devices according to the respective carbon credit value assigned to each server device for the given time period;
monitoring the plurality of server devices; and
updating the ordered data structure based on monitoring the plurality of server devices.

9. The computer system of claim 8, wherein each time period of the plurality of different time periods is one of an hour, a day, a week, a month, or a year.

10. The computer system of claim 8, wherein the factors that influence carbon emissions of the plurality of server devices include one or more of power sources of the plurality of server devices, ages of the plurality of server devices, geographical locations of the plurality of server devices, or cooling systems of the plurality of server devices.

11. The computer system of claim 8, wherein the operations further comprise:
utilizing the ordered data structure to select, based on the respective carbon credit value assigned to each server device for the given time period, one of the plurality of server devices to process requests generated by an application for the given time period.

12. The computer system of claim 11, wherein utilizing the ordered data structure to select the one of the plurality of server devices comprises:
utilizing a binary search tree model with the ordered data structure to select the one of the plurality of server devices.

13. The computer system of claim 11, wherein utilizing the ordered data structure to select the one of the plurality of server devices comprises:
traversing through the ordered data structure based on predetermined conditions to select the one of the plurality of server devices.

14. The computer system of claim 11, wherein the operations further comprise:
generating a warning if the one of the plurality of server devices does not have a quantity of carbon credits sufficient to process the requests generated by the application for the given time period.

15. A computer program product, comprising:
one or more non-transitory computer-readable storage media; and
program instructions stored on the one or more non-transitory computer-readable storage media to perform operations comprising:
receiving server data identifying a plurality of server devices and factors that influence carbon emissions of the plurality of server devices;
calculating, for each server device of the plurality of server devices and for each time period of a plurality of different time periods, a respective carbon credit value for the server device to execute a unit of work during the time period, wherein calculating the respective carbon credit value includes calculating carbon emissions attributable to execution of the unit of work by the server device during the time period based on an estimated power consumption of the server device and a carbon intensity of a power source utilized to generate power for the server device;
assigning, for each server device and each time period, the respective carbon credit value to the server device for the time period based on the calculated carbon emissions;
generating an ordered data structure that, for a given time period of the plurality of different time periods, arranges identifiers of the plurality of server devices according to the respective carbon credit value assigned to each server device for the given time period;
receiving application data identifying an application provided by the plurality of server devices and historical requests associated with the application; and
calculating an average carbon credit required by the application based on the application data.

16. The computer program product of claim 15, wherein the operations further comprise:
receiving a request for the application;
calculating a required carbon credit for the application for the given time period based on the request, predicted future requests, and the average carbon credit required by the application; and
identifying, in the ordered data structure, one of the plurality of server devices to execute the request based on the required carbon credit for the application for the given time period.

17. The computer program product of claim 16, wherein the operations further comprise:
assigning the request for the application to the one of the plurality of server devices.

18. The computer program product of claim 16, wherein calculating the required carbon credit for the application for the given time period comprises:
calculating the required carbon credit for the application for the given time period based on historical data associated with the application.

19. The computer program product of claim 15, wherein each time period of the plurality of different time periods is one of an hour, a day, a week, a month, or a year.

20. The computer program product of claim 15, wherein the factors that influence carbon emissions of the plurality of server devices include one or more of power sources of the plurality of server devices, ages of the plurality of server devices, geographical locations of the plurality of server devices, or cooling systems of the plurality of server devices.
